(19) United States
(12) Patent Application Publication
(10) Pub. No.: US 2009/0308198 A1
(43) Pub. Date: Dec. 17, 2009

(54) Starter System with Integral Clutch Pinion for Start-Stop Engine Cranking

(76) Inventors: Martin Jastrzembowski, Brighton, MI (US); Wei Xue, Northville, MI (US); Ravi Atluru, Westland, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 12/140,574

(22) Filed: Jun. 17, 2008

(51) Int. Cl. F02N 15/02

(52) U.S. Cl. 74/7 C; 74/6

(57) ABSTRACT

A torque transfer system for cranking an engine includes a starter motor, an engine crankshaft, a pinion, a ring gear engaged with the pinion and driveably connected to the crankshaft, and a one-way clutch for alternately opening and closing a drive connection between the pinion and the starter motor.

### BACKGROUND OF THE INVENTION

1. Field of the Invention

This invention relates generally to an apparatus for starting an internal combustion engine, and, in particular, to a start-stop engine cranking system.

2. Description of the Prior Art

An electrical starting motor is used to crank and start an engine in an automotive vehicle. Under normal driving conditions, the engine continues to run after it is cranked by a starting motor. To improve fuel economy, a stop-start engine cranking system turns the engine off after the vehicle stops for a predetermined period, and automatically restarts the engine in response to the vehicle operator's depressing the accelerator pedal, which indicates a desire to accelerate the vehicle. These actions occur without need to turn the ignition key either on or off.

In one version of a stop-start engine cranking system a pinion is permanently engaged with a ring gear, which is driveably connected to the engine. The starting motor does not include an overrun clutch, but, instead, the overrunning clutch is located on the engine flywheel or drive plate, where the engine ring gear is located.

When the engine misfires while attempting to start the engine by cranking it, a large torsion load is transmitted from engine to the starting motor through the ring gear and the starting motor pinion. This torsion load can cause damage to the ring gear and starting motor, or significantly reduce the service life of the ring gear and starting motor. Repair of the ring gear requires a long period and large cost.

A need exists in the industry for a technique to protect the ring gear and starting motor if the engine should misfire or another overload torque condition occurs while the engine is being cranked by a starter motor in a stop-start engine cranking system.

### SUMMARY OF THE INVENTION

A cranking system starter system for a start-stop cranking system includes an electric motor, an engine crankshaft, a pinion, a ring gear engaged with the pinion and driveably connected to the crankshaft, and a one-way clutch, which alternately opens and closes a drive connection between the pinion and the starter motor and functions as a torque limiter.

A method for operating an engine cranking system includes the steps of securing a ring gear to an engine crankshaft, driveably connecting a pinion to the ring gear, locating a torque limiter one-way clutch in a drive path between the pinion and a starter motor, operating the starter motor, and transmitting torque produced by the starter motor through the one-way clutch, pinion and gear to the crankshaft.

To protect the ring gear and starting motor, an integral pinion and one-way clutch are arranged in series in a drive path between the starter motor and the engine crankshaft. The one-way clutch is engaged while cranking the engine and disengages when a negative torque is applied to the crankshaft by the misfiring engine.

In this way, the integrated one-way clutch releases the drive connection between the starter pinion and motor and the starter shaft. The release avoids damage to the assembly and repair costs.

Yet the system improves fuel economy by permitting the engine to be shut off when the engine idles for a period of predetermined length and by automatically starting the engine in response to a demand for increased wheel torque.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawings, in which:

FIG. 1 is a longitudinal cross section taken at a diametric plane through an engine starter having an integral pinion clutch;

FIG. 2 is a schematic diagram of an engine starter system that includes an engine starter having a pinion and a clutch, which functions as a torque limiter;

FIG. 3 is lateral cross section taken at a diametric plane through the starter of FIGS. 1 and 2 showing a front view of the pinion, pinion clutch and shaft;

FIG. 4 is a longitudinal cross section taken at a diametric plane through an engine starter having a modular pinion-clutch, which functions as a torque limiter; and

FIG. 5 is a lateral cross section taken at a diametric plane through the engine starter of FIG. 4 showing a front view of the pinion, pinion-clutch and sleeve subassembly.

### DESCRIPTION OF THE PREFERRED EMBODIMENT

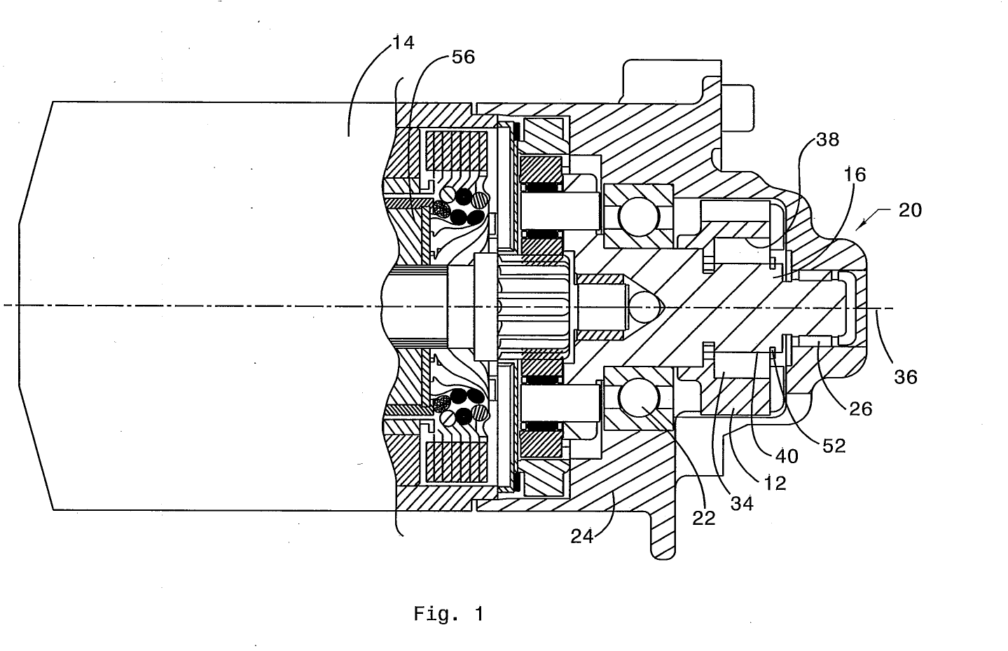

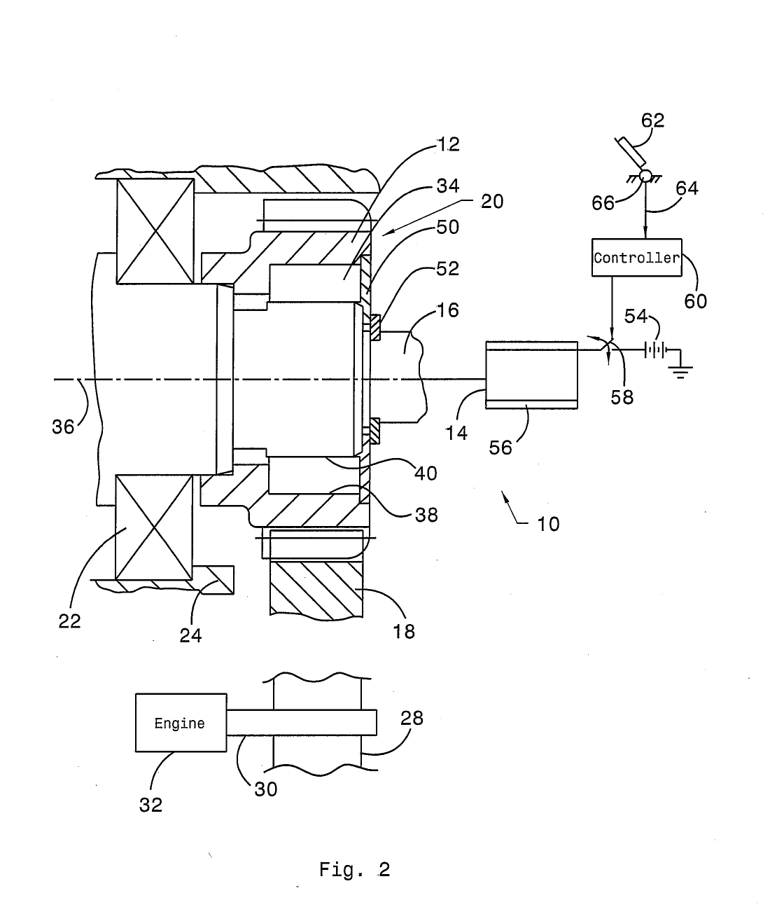

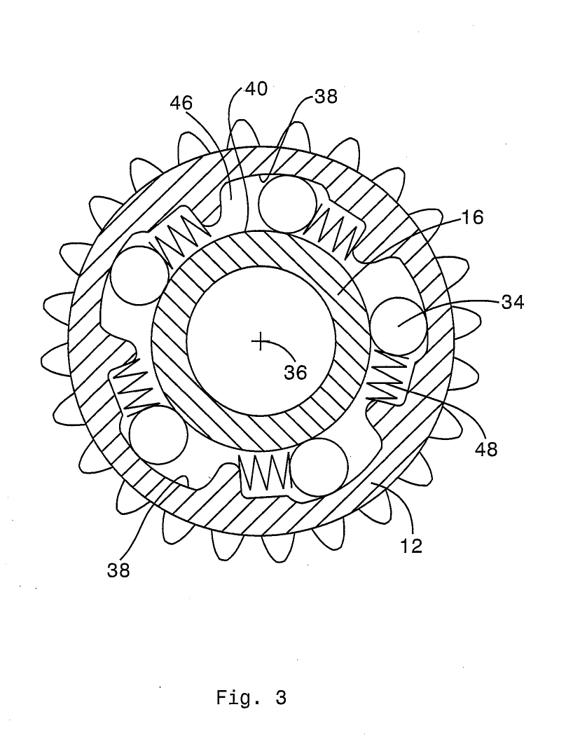

Referring now to FIGS. 1-3, an engine starter 10 system includes a pinion 12; a starter motor 14; a shaft 16 driveably connected to the motor and pinion; a ring gear 18 engaged with the pinion; and a one-way clutch (OWC) 20, supported on the shaft for alternately opening and closing a drive connection between the shaft and pinion.

Shaft 16 is supported for rotation on a bearing 22, which is secured to a starter housing 24, and another bearing 26, located at the right-hand side of pinion 12.

The ring gear 18 is formed on a flywheel 28, which is driveably connected to a crankshaft 30 of an engine 32 with a OWC (not shown).

One-way clutch 20 includes a set of clutch actuation elements 34, preferably in the form of rollers or balls, spaced mutually about an axis 36. Each clutch element 34 is located in a annular space, which is bounded by an outer surface 38 formed on pinion 12 and having a slight radial incline, and an inner cylindrical surface 40 formed on shaft 16. Either the inner surface 40 or outer surface 38 is formed with inclined ramps, each ramp extending toward surfaces 38, 40 and spaced angularly about axis 36 from the other ramps.

The depth of each space, i.e., the radial distance between surfaces 38, 40, decreases along each ramp 38 such that each clutch element 34 engages surfaces 38, 40 when the element 34 moves toward the shallow end of the respective space. Each clutch actuating element 34 disengages surfaces 38, 40 when the clutch actuating element moves to the deeper end of the respective space.

A spring 48, located in each of the annular spaces between surfaces 38, 40, urges a clutch actuating element 34 along its respective ramp 38 and away from the clutch engagement position.

Each of the rollers 34 alternately ascends and descends a respective ramp 38, in response to the force of the respective spring 48, the direction of torque carried by pinion 12 and shaft 16, and the relative rotary speed of the pinion and shaft about axis 32.

A seal ring 50, secured to shaft 16 by a snap ring 52, closes the annular space and seals it against entry of contaminants and the loss of lubricant located in the space.

The system 10 further includes a source 54 of electric power, an armature 56 of the starter motor 14, a switch 58 for opening and closing a connection between power source 54 and armature 56, and a controller 60 for changing the state of switch 58. The position of an accelerator pedal 62, i.e., the extent to which the pedal is displaced by the vehicle operator, is represented by a signal 64 produced by a position sensor 66. Controller 60 receives signal 64 as input and determines from that signal whether the operator is causing the engine to idle or is demanding an increase in wheel torque. The controller 60 alternately turns off engine if the engine 32 remains in idle mode for a predetermined period and restarts the engine when a demand for wheel torque is present.

In normal operation, when switch 58 is closed to crank and start the engine 32, the clutch actuating elements 34 move against the force of springs 48 radially into engagement with surfaces 38, 40, the OWC 20 engages, and a drive connection among starter motor 14, shaft 16, pinion 12, ring gear 18 and crankshaft 30 is produced causing starter motor 14 to drive pinion 12 about axis 32 and the engine crankshaft 30 to rotate about its axis at a speed that corresponds to the speed reduction produced by the engagement of pinion 12 with ring gear 18. Thus, positive torque is transmitted from the armature 56 of starter motor 14 to the crankshaft 26.

After the speed of crankshaft 30 reaches a speed at which engine combustion can be sustained, combustion of an air-fuel mixture occurs in the combustion chambers of the engine, either in response to a spark produced by spark plugs controlled by an engine ignition system, in the case of a gasoline engine, or spontaneously, in the case of a diesel engine.

After sustainable engine ignition occurs, controller 60 opens switch 58, which opens the connection to the electric power source 54, causing the starter motor 14 to produce no torque. Consequently, the clutch elements 34 move away from engagement with surfaces 38, 40 due to the force of springs 48, the OWC 20 disengages, and the drive connection opens allowing pinion 12 and starter shaft 16 to rotate independently of crankshaft 30.

Occasionally, an engine misfire or an engine back-rock occurs while cranking the engine 32. The misfire or back rock creates a large magnitude of negative torque and causes a large reverse impact load to be transmitted in the direction from ring gear 18 toward starter pinion 12. That negative torque exceeds the predetermined torsion limit. Thus slip occurs between clutch actuating elements 34 and inner surface 40. The slippage causes the OWC 20 to disengage and makes OWC 20 working as a torque limiter. When a misfire or engine back-rock occurs, therefore, the slipping OWC 20 opens the drive connecting between pinion 12 and ring gear 28, and the large negative torque cannot be transmitted from the engine crankshaft 30, ring gear 18, starter pinion 12 to starter motor 14. Thus, the disengaged OWC 20 prevents damage of the stop-start cranking system 10 due to the negative torque and impact torsion load that would have been applied to system 10 from engine 32.

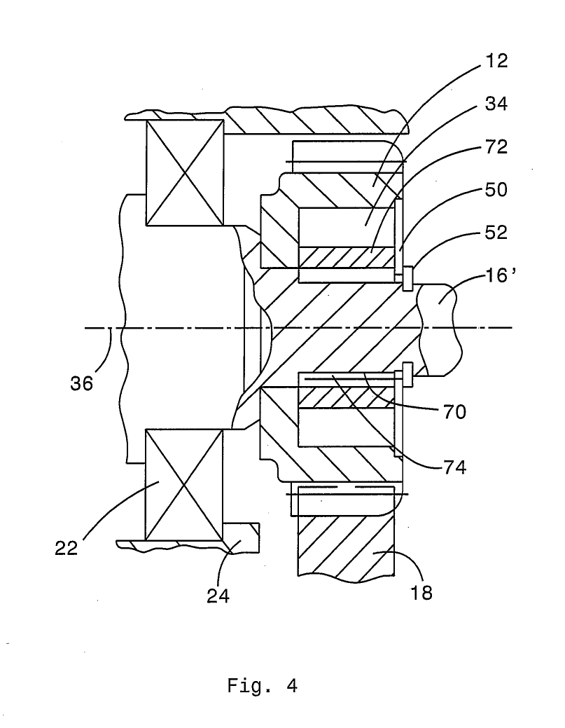

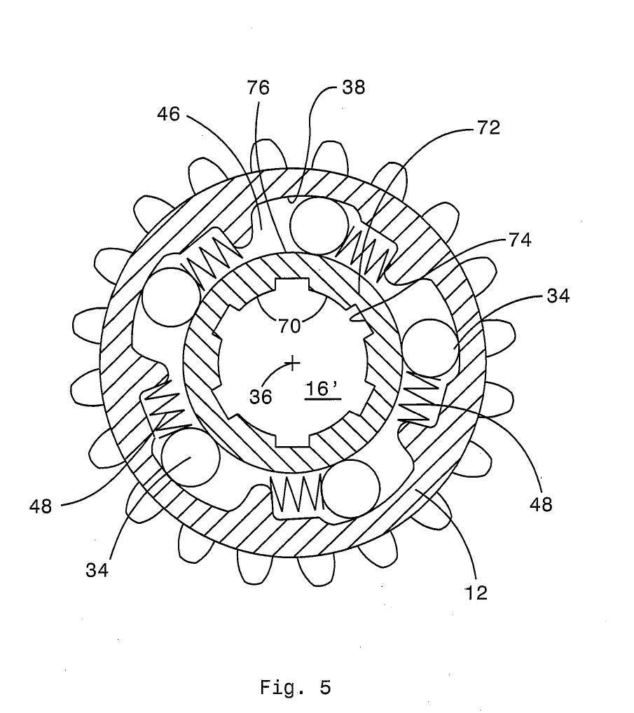

Referring now to the modular, integral pinion and torque limiter for the engine starter shown in FIGS. 4 and 5, the outer surface 70 of shaft 16 is a partial cylindrical surface having external spine teeth. A sleeve 72, formed with an internal spline 74, is supported on surface 70 and driveably connected to the shaft 16 for rotation about axis 36. Seal ring 50 prevents axial translation of sleeve 72, and the snap ring 52 secures the clutch elements and sleeve in position of the shaft 16. The outer surface 76 of sleeve is cylindrical and axially aligned with axis 36 and pinion 12.

As FIGS. 4 and 5, illustrate the pinion 12, sleeve 72, clutch elements 34, springs 48, and seal 50 form a modular subassembly that can be assembled separately from the starter motor 14, transported as a unit, installed in the housing 24 over shaft 16, and secured in position on the shaft by seal ring 50 and snap ring 52.

In normal operation, when switch 58 is closed to crank and start the engine 32, the clutch elements 34 move against the force of springs 48 radially into engagement with surfaces 38, 76, the OWC 20 engages, and a drive connection among starter motor 14, shaft 16, sleeve 72, pinion 12, ring gear 18 and crankshaft 30 is produced causing starter motor 14 to drive pinion 12 about axis 32 and the engine crankshaft 30 to rotate about its axis at a speed that corresponds to the speed reduction produced by the engagement of pinion 12 with ring gear 18. Thus, positive torque is transmitted from the armature 56 of starter motor 14 to the crankshaft 26.

After the speed of crankshaft 30 reaches a speed at which engine combustion can be sustained, combustion of an air-fuel mixture occurs in the combustion chambers of the engine, either in response to a spark produced by spark plugs controlled by an engine ignition system, in the case of a gasoline engine, or spontaneously, in the case of a diesel engine.

After sustainable engine ignition occurs, controller 60 opens switch 58, which opens the connection to the electric power source 54.

In accordance with the provisions of the patent statutes, the preferred embodiment has been described. However, it should be noted that the alternate embodiments can be practiced otherwise than as specifically illustrated and described.

The invention claimed is:

1. A torque transfer system for cranking an engine, comprising:
a starter motor;
an engine crankshaft;
a pinion;
a ring gear engaged with the pinion and driveably connected to the crankshaft; and
a one-way clutch for alternately opening and closing a drive connection between the pinion and the starter motor.

2. The torque transfer system of claim 1, wherein the pinion is supported for rotation about a first axis, and the ring gear is supported for rotation about a second axis substantially parallel to the first axis.

3. The torque transfer system of claim 1, wherein the pinion is disposed for continual engagement with the ring gear.

4. The torque transfer system of claim 1, further comprising:
a starter shaft driveably connected to the starter motor, supported for rotation about a first axis and including a first surface;
a second surface formed on the pinion and facing the first surface; and
an element of the clutch that moves into engagement with the first surface and the second surface to produce a drive connection between the shaft and the pinion, and that moves away from engagement with the first surface and the second surface to open said drive connection and allow the shaft to rotate independently of the pinion.

5. The torque transfer system of claim 1, further comprising:
an electric power source;
an armature of the starter motor;
a switch for opening and closing a connection between the power source and the armature.

6. The torque transfer system of claim 1, further comprising:
an engine; and
a controller configured to turn the engine off when the engine idles for a predetermined period, to use the starter motor to produce torque in response to a demand for wheel torque, such that torque produced by the starter motor is transmitted through the one-way clutch, the pinion and the gear to the crankshaft, and to turn the starter motor off when engine ignition is sustained.

7. A torque transfer system for cranking an engine, comprising:
a starter motor that includes a motor shaft;
a pinion formed with a first engagement surface;
a sleeve driveably connected to the motor shaft and formed with a second engagement surface;
a clutch element located between and the first and second engagement surfaces and displaceable alternately toward engagement with and disengagement from the along the first and second engagement surfaces; and
a spring for urging displacement of the clutch element with respect to the first and second engagement surfaces.

8. The system of claim 7, further comprising:
an engine crankshaft; and
a ring gear engaged with the pinion and driveably connected to the crankshaft.

9. The system of claim 7, further comprising a ring for engaging the motor shaft and securing the pinion, the sleeve, and the clutch element in position on the motor shaft.

10. The torque transfer system of claim 7, further comprising:
an electric power source;
an armature of the starter motor;
a switch for opening and closing a connection between the power source and the armature.

11. The torque transfer system of claim 7, further comprising:
an engine that includes an engine crankshaft;
a ring gear engaged with the pinion and driveably connected to the crankshaft; and
a controller configured to turn the engine off when the engine idles for a predetermined period, to use the starter motor to produce torque in response to a demand for wheel torque, such that torque produced by the starter motor is transmitted to the pinion and the gear to the crankshaft, and to turn the starter motor off when engine ignition is sustained.

12. The torque transfer system of claim 7, wherein the pinion is disposed for continual engagement with the ring gear.

13. A method for operating an engine cranking system comprising the steps of:
(a) securing a ring gear to an engine crankshaft;
(b) driveably connecting a pinion to the ring gear;
(c) locating a one-way clutch in a drive path between the pinion and a starter motor;
(d) operating the starter motor; and
(e) transmitting torque produced by the starter motor through the one-way clutch, the pinion and the gear to the crankshaft.

14. The method of claim 13 wherein step (d) further comprises:
connecting a source of electric power to an armature of the starter motor; and
cranking the engine by using a switch to close a connection between the source of electric power and the armature of the starter motor.

15. The method of claim 13 further comprising the steps of:
producing sustained ignition in the engine; and
discontinuing operation of the starter motor.

16. The method of claim 13, wherein the step of driveably connecting a pinion to the ring gear comprises connecting the pinion to the ring gear for continual engagement of the pinion and ring gear.

17. The method of claim 13 further comprising the steps of:
cranking the engine by connecting a source of electric power to an armature of the starter motor;
producing sustained ignition in the engine; and
discontinuing operation of the starter motor.

18. The method of claim 13 further comprising the steps of:
using a controller to cranking the engine by connecting a source of electric power to an armature of the starter motor;
producing sustained ignition in the engine; and
using the controller to discontinue operation of the starter motor.

19. The method of claim 13, wherein step (c) further comprises the steps of:
assembling the one-way clutch and the pinion as a subassembly; and
mounting the subassembly on a starter motor shaft for rotation therewith.
